(19) United States
(12) Patent Application Publication
(10) Pub. No.: US 2022/0327957 A1
(43) Pub. Date: Oct. 13, 2022

(54) GAME BOARD SYSTEM, APPLICATION GAMEPLAY SYSTEM, EDUCATIONAL GAME, PROCESS OF PLAYING, METHOD OF USE, AND METHOD OF TEACHING THEORY AND INVESTING IN REAL ESTATE

(71) Applicant: Frank Johnson, III, Lakeland, FL (US)

(72) Inventor: Frank Johnson, III, Lakeland, FL (US)

(21) Appl. No.: 17/705,504

(22) Filed: Mar. 28, 2022

Related U.S. Application Data
(60) Provisional application No. 63/173,385, filed on Apr. 10, 2021.

(51) Int. Cl. G09B 19/18; G09B 5/02

(52) U.S. Cl. CPC G09B 19/18; G09B 5/02

(57) ABSTRACT

A game board system, application gameplay system, educational game, process of playing, method of use, and method of teaching theory and investing in real estate are presented. The learning system with a game board system, application gameplay system, educational game, process of playing, method of use, and method of teaching theory and investing in real estate are presented. Game board and application gameplay systems are designed and are configured to fulfill the goals of education in the financial field and associate real-life knowledge and learning. In this way, the present disclosure provides for a game board and/or table top game for fun, entertainment and educational purposes.

### CROSS-REFERENCE TO RELATED APPLICATIONS

The present application claims priority to the U.S. Provisional Patent Application No. 63/173,385 which was filed on Apr. 10, 2021, which is hereby incorporated by reference herein in its entirety, including any figures, tables, or drawings.

### FIELD OF THE DISCLOSURE

This disclosure relates to a game board system, application gameplay system, educational game, process of playing, method of use, and method of teaching theory and investing in real estate. More specifically, and without limitation, the present disclosure relates to a table top game. More specifically, and without limitation, the present disclosure relates to a game which can be played on a computer, smart phone, or other electronic device. More specifically, and without limitation, the present disclosure relates to an educational game. More specifically, and without limitation, the present disclosure relates to a method of teaching real estate investing theory and investing in real estate.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. Frank Johnson. All rights reserved.

### BACKGROUND OF THE DISCLOSURE

Games are old and well known in the art. Furthermore, board games are old and well known in the art. Board games are generally table top games or are also referred to as table top games. Generally speaking, and ranging in examples from Monopoly to Clue to Risk, and others, involve a game board, players, and oftentimes a movement of players around the board, along with various interactions and strategies. Other elements of board games might include a table, a card, a set of rules, a role-playing feature, and more.

Oftentimes board games involve a competition between two or more players. However, game boards can also be solitaire gameplay or may involve a player versus a computer, or simulated gameplay of a component which is an automated or processing system managed by computer processing components. As part of the competition between players and/or computer processing units, may involve various strategies and planning. Not all gameplay is based in strategy. Some game play may involve luck, rolls of dice, or other randomly generated moves and/or random outcomes.

A number of board games not only introduce strategy, luck or randomness, but also have a fair amount of diplomacy. Diplomacy, as an aspect of gameplay, can be introduced to a board game through players which must collaborate, team up, or negotiate with each other and/or with a computer processing unit. Similarly, negotiation between two or more players and cooperation can be an important part of convincing, understanding, and teaching life lessons such as elaboration of plans or even teams, and more.

Furthermore, and in addition to strategy, luck or randomness, and diplomacy, some games may offer an educational aspect. As one example of a past board game which offers an educational aspect may be Monopoly, which can teach or educate in counting, purchasing, and some other simple game-like items. Other games may offer some educational aspects which could be spelling along with other educational based games, commonly directed toward early developers or young people.

Games are not limited to board games or tabletop games. Many video games or computer games exist today. As alluded to above, in this way, a player may engage with a computer processing unit, or other players from around the globe to engage in various types of game play while engaging manipulation methods and the like that did not exist in the art until recent years. Furthermore, through online game play or gameplay through game engines and through internet connections, manipulation of game boards through automated means or electronic environments has become possible. Furthermore, a combination of physical and electronic or internet driven gameplay is also possible, such as tabletop simulators and the like.

Real estate, and particularly, real estate investing is old and well known in the art. Real estate investing often involves the purchase, ownership, management, rental, temporary rental, and/or sale of real estate for profit. Sometimes this involves flipping and/or buying a home, repairing and/or updating and/or upgrading the home, and then selling the home for profit. These types of improvements to real estate property as part of real estate investing strategy is generally considered to be a subset of real estate investing. So, there are various types of real estate investing and investments that can be tools for a person to generate passive, substantial, or significant capital and income. Real estate investment can be very risky, so a lack of understanding can also cause substantial loss for a person.

Success in real estate investing can also sometimes depend on the investors understanding of broader real estate markets. Oftentimes what may seem like investment in an individual property is anything but straightforward. Even individual properties, lots, homes, apartment buildings and the like are not directly interchangeable, present unique problems, can be tied to various asset types, can be subject to different taxation, and various interest rates, laws, and the like. For these reasons, loathing properties in which to invest and understanding some of the various financial and other complexities can involve a substantial amount of time and work.

Thus, an understanding of the basic concepts of real estate investment can benefit a great number of individuals and entities. Teaching real estate investment or learning real estate investment, especially for younger individuals, perhaps a simple first time home buyer, is a foreign topic that at, at times, best takes place through a banker at the time of closing on a home. Therefore, there is a need in the art for a fun way to learn real estate investing. There is a need in the art to take some complex ideas and provide a general understanding for those wishing to be complex investors someday, or perhaps those that don't even know they may one day wish to purchase a home of their own.

The disclosure herein provides these advantages and others as will become clear from the specification and claims provided.

### SUMMARY OF THE DISCLOSURE

A game board system, application gameplay system, educational game, process of playing, method of use, and method of teaching theory and investing in real estate are presented. More specifically, and without limitation, the present disclosure relates to a table top game. More specifically, and without limitation, the present disclosure relates to a game which can be played on a computer, smart phone, or other electronic device. More specifically, and without limitation, the present disclosure relates to an educational game. More specifically, and without limitation, the present disclosure relates to a method of teaching real estate investing theory and investing in real estate.

In the arrangement shown, as one example, a board game system suitable for a table top is presented. This board game is fun and entertaining and can also serve as an educational tool for teaching various items related to finance and/or real estate and/or real estate investing. Furthermore, the present disclosure also can operate and/or inter operate simultaneously with an electronic version.

Said another way, the present disclosure also provides an electronic version of gameplay that can be played and/or enjoyed on a smart device, computer, smartphone (such as through a mobile application), a tablet, and the like. Similarly, moves can be implemented via the real life gameplay and also interact with electronic devices such that electronic devices can keep track of data such as financial ledgers, transactions, game cards, property owned, property available, and more. In this way, the present disclosure provides the state of the art with a fun, interactive fun board game, online game, and real estate educational tool and/or real estate investing educational tool which makes gameplay fun and easy while tracking data electronically and integrating rules of the game electronically. The electronic version is not required for gameplay in some embodiments.

Thus, it is a primary object of the disclosure to provide a game board system, application gameplay system, educational game, process of playing, method of use, and method of teaching theory and investing in real estate.

Another object of the disclosure is to provide a game board system, application gameplay system, educational game, process of playing, method of use, and method of teaching theory and investing in real estate that improves upon the state of the art for board games and/or table top games.

Yet another object of the disclosure is to provide a game board system, application gameplay system, educational game, process of playing, method of use, and method of teaching theory and investing in real estate that improves upon the state of the art of electronic games which also serve as real estate investing educational tools.

Another object of the disclosure is to provide a game board system, application gameplay system, educational game, process of playing, method of use, and method of teaching theory and investing in real estate that provides a table top board and/or mat for gameplay.

Yet another object of the disclosure is to provide a game board system, application gameplay system, educational game, process of playing, method of use, and method of teaching theory and investing in real estate that provides a booklet of rules for gameplay.

Another object of the disclosure is to provide a game board system, application gameplay system, educational game, process of playing, method of use, and method of teaching theory and investing in real estate that provides an electronic version for gameplay.

Yet another object of the disclosure is to provide a game board system, application gameplay system, educational game, process of playing, method of use, and method of teaching theory and investing in real estate that provides for online gameplay.

Another object of the disclosure is to provide a game board system, application gameplay system, educational game, process of playing, method of use, and method of teaching theory and investing in real estate that provides for users to connect and play with other users at remote locations.

Yet another object of the disclosure is to provide a game board system, application gameplay system, educational game, process of playing, method of use, and method of teaching theory and investing in real estate that provides a predetermined set of rules for online gameplay.

Another object of the disclosure is to provide a game board system, application gameplay system, educational game, process of playing, method of use, and method of teaching theory and investing in real estate that provides for interaction between board gameplay and online gameplay.

Yet another object of the disclosure is to provide a game board system, application gameplay system, educational game, process of playing, method of use, and method of teaching theory and investing in real estate that provides avatars for online gameplay.

Another object of the disclosure is to provide a game board system, application gameplay system, educational game, process of playing, method of use, and method of teaching theory and investing in real estate that provides pawns or avatars for board gameplay.

Yet another object of the disclosure is to provide a game board system, application gameplay system, educational game, process of playing, method of use, and method of teaching theory and investing in real estate that includes aspects of luck or chance.

Another object of the disclosure is to provide a game board system, application gameplay system, educational game, process of playing, method of use, and method of teaching theory and investing in real estate that teaches aspects of interest.

Yet another object of the disclosure is to provide a game board system, application gameplay system, educational game, process of playing, method of use, and method of teaching theory and investing in real estate that teaches aspects of various societal levels of stability and macro-economics.

Another object of the disclosure is to provide a game board system, application gameplay system, educational game, process of playing, method of use, and method of teaching theory and investing in real estate that provides educational aspects of value of an investment.

Yet another object of the disclosure is to provide a game board system, application gameplay system, educational game, process of playing, method of use, and method of teaching theory and investing in real estate that teaches property ownership ideas.

Another object of the disclosure is to provide a game board system, application gameplay system, educational game, process of playing, method of use, and method of teaching theory and investing in real estate that provides educational aspects of homeowners associations and implications.

Yet another object of the disclosure is to provide a game board system, application gameplay system, educational game, process of playing, method of use, and method of teaching theory and investing in real estate that provides educational aspects market conditions.

Another object of the disclosure is to provide a game board system, application gameplay system, educational game, process of playing, method of use, and method of teaching theory and investing in real estate that provides educational aspects of income.

Yet another object of the disclosure is to provide a game board system, application gameplay system, educational game, process of playing, method of use, and method of teaching theory and investing in real estate that provides educational aspects of offers for buying and selling property.

Another object of the disclosure is to provide a game board system, application gameplay system, educational game, process of playing, method of use, and method of teaching theory and investing in real estate that provides educational aspects of mortgages.

Yet another object of the disclosure is to provide a game board system, application gameplay system, educational game, process of playing, method of use, and method of teaching theory and investing in real estate that provides educational aspects of collaboration.

Another object of the disclosure is to provide a game board system, application gameplay system, educational game, process of playing, method of use, and method of teaching theory and investing in real estate that provides educational aspects of refinancing.

Yet another object of the disclosure is to provide a game board system, application gameplay system, educational game, process of playing, method of use, and method of teaching theory and investing in real estate that provides educational aspects related to taxes.

Another object of the disclosure is to provide a game board system, application gameplay system, educational game, process of playing, method of use, and method of teaching theory and investing in real estate that provides educational aspects related to various financial implications.

Yet another object of the disclosure is to provide a game board system, application gameplay system, educational game, process of playing, method of use, and method of teaching theory and investing in real estate that teaches the theory of investing in real estate.

Another object of the disclosure is to provide a game board system, application gameplay system, educational game, process of playing, method of use, and method of teaching theory and investing in real estate that provides a game board with four sections.

Yet another object of the disclosure is to provide a game board system, application gameplay system, educational game, process of playing, method of use, and method of teaching theory and investing in real estate that provides educational aspects related to various property types.

Another object of the disclosure is to provide a game board system, application gameplay system, educational game, process of playing, method of use, and method of teaching theory and investing in real estate that provides for investment portfolios.

Yet another object of the disclosure is to provide a game board system, application gameplay system, educational game, process of playing, method of use, and method of teaching theory and investing in real estate that dynamically can change depending on outcomes of gameplay such as where players land, and the value of various spaces within gameplay.

Another object of the disclosure is to provide a game board system, application gameplay system, educational game, process of playing, method of use, and method of teaching theory and investing in real estate that dynamically changes in both positive and negative ways.

Yet another object of the disclosure is to provide a game board system, application gameplay system, educational game, process of playing, method of use, and method of teaching theory and investing in real estate that is fun.

Another object of the disclosure is to provide a game board system, application gameplay system, educational game, process of playing, method of use, and method of teaching theory and investing in real estate that is easy to set up and implement gameplay.

Yet another object of the disclosure is to provide a game board system, application gameplay system, educational game, process of playing, method of use, and method of teaching theory and investing in real estate that accommodates various numbers of players.

Another object of the disclosure is to provide a game board system, application gameplay system, educational game, process of playing, method of use, and method of teaching theory and investing in real estate that is easy to use.

Yet another object of the disclosure is to provide a game board system, application gameplay system, educational game, process of playing, method of use, and method of teaching theory and investing in real estate that provides a set of rules that is relatively easy to follow and implement.

Another object of the disclosure is to provide a game board system, application gameplay system, educational game, process of playing, method of use, and method of teaching theory and investing in real estate that is easy to start.

Yet another object of the disclosure is to provide a game board system, application gameplay system, educational game, process of playing, method of use, and method of teaching theory and investing in real estate that involves various strategies.

Another object of the disclosure is to provide a game board system, application gameplay system, educational game, process of playing, method of use, and method of teaching theory and investing in real estate that provides players with a variety of options and decision making.

Yet another object of the disclosure is to provide a game board system, application gameplay system, educational game, process of playing, method of use, and method of teaching theory and investing in real estate that provides for educational aspects related to tax and/or taxation.

Another object of the disclosure is to provide a game board system, application gameplay system, educational game, process of playing, method of use, and method of teaching theory and investing in real estate that provides for educational aspects related to finance, refinance, and/or mortgages.

Yet another object of the disclosure is to provide a game board system, application gameplay system, educational game, process of playing, method of use, and method of teaching theory and investing in real estate that provides for educational aspects related to flipping.

Another object of the disclosure is to provide a game board system, application gameplay system, educational game, process of playing, method of use, and method of teaching theory and investing in real estate that provides for educational aspects related to paying and/or collecting rent.

Yet another object of the disclosure is to provide a game board system, application gameplay system, educational game, process of playing, method of use, and method of teaching theory and investing in real estate that works with various smartphone applications.

Another object of the disclosure is to provide a game board system, application gameplay system, educational game, process of playing, method of use, and method of teaching theory and investing in real estate that works with various smartphone devices and/or computing devices.

Yet another object of the disclosure is to provide a game board system, application gameplay system, educational game, process of playing, method of use, and method of teaching theory and investing in real estate that is safe to use.

Another object of the disclosure is to provide a game board system, application gameplay system, educational game, process of playing, method of use, and method of teaching theory and investing in real estate that is accurate.

Yet another object of the disclosure is to provide a game board system, application gameplay system, educational game, process of playing, method of use, and method of teaching theory and investing in real estate that is robust.

Another object of the disclosure is to provide a game board system, application gameplay system, educational game, process of playing, method of use, and method of teaching theory and investing in real estate that can integrate hardware and various platforms.

Yet another object of the disclosure is to provide a game board system, application gameplay system, educational game, process of playing, method of use, and method of teaching theory and investing in real estate that is quick and efficient.

Another object of the disclosure is to provide a game board system, application gameplay system, educational game, process of playing, method of use, and method of teaching theory and investing in real estate that provides a user interface.

Yet another object of the disclosure is to provide a game board system, application gameplay system, educational game, process of playing, method of use, and method of teaching theory and investing in real estate that provides an application interface.

Another object of the disclosure is to provide a game board system, application gameplay system, educational game, process of playing, method of use, and method of teaching theory and investing in real estate that can be programmed to various rule sets.

Yet another object of the disclosure is to provide a game board system, application gameplay system, educational game, process of playing, method of use, and method of teaching theory and investing in real estate that saves time for a user.

Another object of the disclosure is to provide a game board system, application gameplay system, educational game, process of playing, method of use, and method of teaching theory and investing in real estate that is effective for various ages.

These and other objects, features, or advantages of the present disclosure will become apparent from the specification and claims.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the FIGURES provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached FIGURES illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In the arrangement shown, as one example, a game board system, application gameplay system, educational game, process of playing, method of use, and method of teaching theory and investing in real estate are presented. Game board and application gameplay systems are formed of any suitable size, shape, and design and are configured to fulfill the goals of the disclosure as described herein. The present disclosure provides for a game board and/or table top game for fun, entertainment and educational purposes.

In addition to the board game and physical components, the present disclosure includes electronic gameplay and includes data transfer and/or data capture to accomplish the functionality further described herein. Some of this data capture includes, but is not limited to a plurality of users within gameplay, a ledger, accounting for various transactions, tracking tax rates for various tiers, tracking a players balance, tracking property owned, tracking property transferred, tracking historical gameplay data, tracking property owned, tracking travel within gameplay, tracking cards or other assets a player may acquire and/or sell and/or trade, capturing images, object recognition within images, counting of objects within images, tracking global positioning, and other information can be used to create customized information, identify patterns, and more. These components, functionalities, and other features are further described herein.

In the arrangement shown, as one example, system 10 provides the state of the art with a tabletop or game board to teach the theory of investing in real estate. In the arrangement shown, as one example, the board 20 (to be further discussed herein) is divided into 4 sections in the shape of a pyramid. Furthermore, in the arrangement shown, as one example, board 20 includes 3 different property types. Furthermore, in the arrangement shown, as one example, board 20 includes various property types which also can have 2 different conditions.

In the arrangement shown, as one example, users start gameplay with a pawn or avatar 50 (to be further discussed herein) located at the bottom right. In the arrangement shown, as one example, each player begins with $50,000 in their account and/or ledger (to be further discussed herein). Furthermore, in this arrangement, each player begins with a blank portfolio (to be further discussed herein).

In the arrangement shown, as one example, system 10 also includes an application server (to be further described herein). The application server provides a ledger and the record of real estate transactions for each player during gameplay as well as a record of what property each player owns. In this way, the application can update a player's account and portfolio, and/or balance, while the game progresses. Other game play information is also stored on the application and updated for each player including, but not limited to, history, cards drawn, market conditions, and other information related to gameplay.

In the arrangement shown, as one example, the board 20 (to be further described herein) includes spaces on which players land that affect the value or interest of the property on the board, and which affect the strategies of players, and the like. Players might also land on spaces which do not affect the whole board or other players but instead has an impact largely only on the player; this could be in positive or negative ways.

In the arrangement shown, as one example, players engage with gameplay through buying, selling, and/or holding real estate at various times. In this way, players can increase their income and the like to acquire more property during gameplay as prices of property vary during gameplay and the like. Various rules apply for which a player can win the game. For example, in one arrangement, once a player owns 3 of the 4 commercial properties at the top of the pyramid, or owns 5 properties free and clear, or owns all the property along a given row in the game, the player wins the game.

System:

With reference to the FIGURES, a game board system, application gameplay system, educational game, process of playing, method of use, and method of teaching theory and investing in real estate 10 are presented. Game board system, application gameplay system, educational game, process of playing, method of use, and method of teaching theory and investing in real estate 10 (hereafter referred to as “game board system”, “board game system”, “table top system”, “electronic gameplay system”, “educational game”, or simply “system”) is formed of any suitable size, shape and design.

In the arrangement shown, as one example, game board system 10 may comprise remote servers, databases, application servers, application databases, product databases, mobile applications, and/or computers; all of which in continuity or as separate acts fulfill the functions disclosed herein. Board game system 10 also includes, in the embodiment(s) depicted, a graphical user interface 12, a plurality of users 14, a plurality of dice 16, a rules booklet 18, a board 20, an avatar 50, value cards 60, interest cards 70, peace cards 80, crises cards 90, deed cards 100, home ownership association cards 110, pawns 120, stickers 130, an application programming interface 200, an application 202, a smart device 204, a computing system 300, a communication and/or control system 400, an application server, and a mobile computing application, among other components, features, and functions.

In the arrangement shown, as one example, the main structure of system 10 may also include a plurality of attachment features, a plurality of wired connections, a plurality of sensors, an onboard computing system, and communication and control components which may aid in the interaction between the tabletop board game and the electronic version of the board game and/or the simultaneous interactions occurring between and among each of the versions, among other components, features, and functionality.

Graphical User Interface:

In the arrangement shown, as one example, system 10 may include a graphical user interface 12. Graphical user interface 12 is formed of any suitable size shape and design and is configured to allow a user to view, interact with, manipulate, and visually access gameplay and system data and information, information related thereto, and/or view various data for various gameplay information and/or board status and/or add information to the gameplay and/or gameplay environment and/or add information about a game or ongoing game and/or object data and/or change the settings and/or change the rules of gameplay and/or change the settings of interaction between the electronic version and the tabletop version.

Graphical user interface 12 is an exemplary method by which systems of the present disclosure may provide for fun, entertainment, and educational purposes for a user. Employing graphical user interface 12, enhances a user's interactions with system 10 in the form of awareness and knowledge of data within the system 10. System 10 provides direct links to a user's history, settings, programming, and other information related to a particular history of a user and/or a specific game which is being played and/or a particular rule and the like.

In this way graphical user interface 12 provides a means for a user to make adjustments to the game and/or continue gameplay and functionality of system 10. Additionally, graphical user interface 12 provides direct interaction with the board game system, geometrical measurements, objects, ledger accounting, ownership of rights within the game, ownership of property, and more. Additionally, real world historical information with relation to the system can be added, viewed, or retrieved.

Display of Graphical User Interface: In the arrangement shown, as one example, system 10 includes a graphical user interface 12. Graphical user interface 12 may include a display 13, which is configured to show and display information, including data, for review and interpretation by a user or plurality of users, or a plurality of users interacting with one another. In the arrangement shown, as one example, interactive user display is formed of a display screen 13, such as that of a desktop computer, laptop computer, monitor, tablet, smart phone, smart TV, projector, virtual reality display or any other device or form of a display. In the arrangement shown, as one example, interactive user display comprises a series of interactive user display pages (or game board viewing), however, the interactive user display may consist of a single page or any other method of displaying information on a display as could be adapted to various size screens, devices, or user preferences. The interactive user display can display various gameplay and/or interactive game play information which is retrieved and/or requested.

User (or Plurality Thereof):

In the arrangement shown, as one example, system 10 includes at least one user 14. User 14 may be any user interacting with or utilizing the system 10. This may include viewing, controlling, analyzing, manipulating, and/or interacting with system 10. Users are not limited to a single user but may be a plurality of users. Furthermore, a user 14 may interact with a computer processing unit which is exercising automated gameplay such that a user 14 can engage the system and engage in game play without additional users. Furthermore, a user may be a user engaging with system 10 remotely. Users can interact with gameplay from various locations through online services.

Dice:

In the arrangement shown, as one example, system 10 includes a plurality of dice 16. Dice 16 are formed of any suitable size shape and design and are configured to provide a chance and/or random aspect to gameplay. In the arrangement shown, as one example, dice 16 provides for deciding which player will start the game as well as movements about the game play board.

Booklet:

In the arrangement shown, as one example, system 10 includes a booklet 18. Booklet 18 is formed of any suitable size, shape and design and is configured to provide a clear set of rules to a user or group of users. In this way, booklet 18 provides instructions for various gameplay operations and occurrences. Booklet 18 may also include educational and/or other information for users.

Board:

In the arrangement shown, as one example, system 10 includes a board 20. Board 20 (or “mat”, or “tabletop board”) is formed of any suitable size shape and design and is configured to provide the primary physical interaction for gameplay for users.

In the arrangement shown, as one example, the board 20 extends a length 21 from a first end 22 to a second end 23 between opposing sides 24, having a top 25 and a bottom 26. In the arrangement shown, as one example, board 20 includes a plurality of perimeter spaces 27 and an interior field 28. Furthermore, in the arrangement shown, as one example, includes a plurality of outlines 29, a plurality of labels 30, at least one name identifier 31, a plurality of sections 32, a plurality of property types 33, various conditions 34, spaces 35, property spaces 36, value spaces 37, interest spaces 38, peace spaces 39, crises spaces 40, income spaces 41, tax spaces 42, among other features and components.

In the arrangement shown, as one example, the board 20 includes four sections in the shape of a pyramid with three different property types, each property type having potentially two different conditions. The first condition is a property which needs to be repaired or flipped, while the second condition is a property that does not need to be repaired. In the arrangement shown, as one example, the bottom section on the board or foundation of the pyramid includes ten property spaces that are unique from the rest of the board, requiring a player to rehabilitate and/or repair and/or flip the property before refinancing or selling the property. The bottom section, in this way, is also known as “flip street”.

In the arrangement shown, as one example, a left section is included which consists of eight property spaces and is referred to as “single street” in gameplay. Single street consists of single family property. Similarly, the right portion of the board is referred to as “small street” and also consists of eight property spaces. Furthermore, the top section of the pyramid consists of four property spaces and is referred to as “commercial street”.

In the arrangement shown, as one example, in between property spaces is a single peace space or crisis space, depending on board location. The board has four such sections. When a player lands on such a section, they are required to draw a peace or crisis card (to be further described herein), depending on what type of space is landed on. This type of card affects the situation of the player.

Furthermore, in the pyramid, there are four corner spaces that are either “value” or “interest” spaces. These spaces, similarly, and in the arrangement shown as one example would require a player to draw a value card or interest card (to be further described herein) in accordance with how the space is labeled.

Various board arrangements and the like are hereby contemplated for use. The above embodiment depicts one layout. However, various shapes, various section numbers, various property numbers, various property types, and various property conditions are hereby contemplated for use.

Avatars:

In the arrangement shown, as one example, system 10 includes an avatar 50. Avatar 50 is formed of any suitable size, shape and design and is configured to represent a users 14 location on the board game and/or represent the users 14 location on the electronic board game. Furthermore, in this way, an avatar 50 may represent a users account 52, portfolio 54, and the like.

Cards:

In the arrangement shown, as one example, system 10 includes a variety of card types. Cards 60/70/80/90/100/110 are formed of any suitable size shape and design and are configured to provide circumstances in gameplay. In this way, cards include value cards 60, interest cards 70, peace cards 80, crisis cards 90, deed cards 100, home ownership association cards 110, and other cards.

Stickers:

In the arrangement shown, as one example, system 10 includes stickers 130. Stickers 130 are formed of any suitable size, shape and design and are configured to provide representations to the players in a game. These stickers 130 can be used to represent various aspects of gameplay from status to ownership, to condition, and the like.

Application Programming Interface:

In the arrangement shown, as one example, system 10 may include an application programming interface 200. Application programming interface 200 is formed of any suitable size, shape and design and is configured to provide electronic gameplay as well as interactions between potential physical gameplay components and electronic gameplay.

In the arrangement shown, as one example, application programming interface 200 includes an application 202, a smart device 204, a ledger 206, a history 208, cards drawn 210, market conditions 212, income 214, offers 216, mortgage 218, buy (from bank) 220, buy (from flip street) 222, buy (from player) 224, buy card 226, sell property (to bank) 228, sell property (to player) 230, sell card (to player) 232, trade card (with player) 234, use peace card 236, use crisis card 238, refinance 240, collect rent 242, collect home ownership association dues 244, pay crisis card 246, pay tax 248, pay mortgage 250, among other components, features, gameplay interactions, and the like.

Computing Platform:

In the arrangement shown, as one example, system 10 includes a computing platform 300 (or “computer”, or “computer platform”). Computing platform 300 is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer 300. Computer 300 is formed of any suitable size, shape, and design and is configured to provide for the main off-board computing processing and implementation of computer handling of data from data gathering performed within the environment. The data processing may include, but is not limited to, artificial intelligence of sorting and organizing images gathered which may include calculations, tracking, and other components of system 10.

Onboard Computing System:

In one arrangement, as is shown, system 10 may also include an onboard computing system (or “onboard computing device”). Onboarding computing system is formed of any suitable size, shape, and design and may be configured to handle onboard computing operations with the tabletop game board, as may be necessary for the operation of the system 10. Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Computing devices may be formed of and/or include any computing device capable of displaying and manipulating data in the manners described herein. Computing device may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of a computing device, including processor, memory, software and interactive user display, may be co-located with computing devices or located at different geographic locations. That is, computing devices may be made of any form of a device or system that individually or collectively performs the computing operations of system 10.

Printed Circuit Board: In the arrangement shown, as one example, system 10 may include a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device 240, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Remote Computing System:

In one arrangement, as is shown, system 10 includes a remote computing system 500 (or “remote computing device”). Remote computing devices are formed of any suitable size, shape, and design and configured to handle offboard computing operations, as are necessary for the operations of system 10. Remote computing device is connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Computing devices may be formed of any computing device capable of displaying and manipulating data in the manners described herein. Computing devices may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices, including processor, memory, software and interactive user display, may be co-located with computing devices or located at different geographic locations. That is, computing devices may be made of any form of a device or system that individually or collectively performs the computing operations of system 10.

Printed Circuit Board: In the arrangement shown, as one example, system 10 includes a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device 180, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Application Server:

In the arrangement shown, as one example, system 10 comprises remote servers, databases, and/or computers that fulfill the functions disclosed and described herein. In the embodiment depicted, system 10 comprises an application server 600. Application server 600 comprises one or more computer systems adapted to transmit and receive data regarding selected datasets related to various users and/or datasets related to multiple users. Application server 600 is adapted to query databases with unique identification codes to retrieve image information and associated surface information related to various surfaces system 10 has moved over and/or through and gathered data in, and/or has monitored and/or is monitoring.

Application server 600 may transmit game play data and/or game play related documents with respect to a single game and/or multiple games. Application server 600 is also adapted to query a database. This query includes receiving and sending surface identification and game play data. Additionally, application server 600 may communicate with a cloud computing system or a mobile application, which can also be adapted to present the data in a form conducive to being viewed on a mobile device and/or handheld device.

As one of ordinary skill in the art may understand, application server 600, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server 600, and other database procedures may be carried out on computer-readable instructions and data stored on the customer's mobile computing device.

In addition to the above identified features, options, controls, and components, system 10 may also include other features and functionalities, among other options, controls, and components.

In Operation:

Setup/Start:

In one example, board 20 is laid out. Similarly, the application may be activated and/or turned on. Subsequently, the fifteen value and interest cards are shuffled and placed on the board 20 so that the users can access the cards. Next, the twenty-one peace or crisis cards are shuffled and placed on the board 20 so that the users can access the cards. Next, the thirty deed cards are placed next to or near the board 20. Next, the three home ownership association cards are placed near the deed cards. Next, pawns stickers are place. Owners, then select and place their avatars or pawns into the start location.

Gameplay:

Start: In one example, each player rolls both dice included and the highest roller goes first. Subsequently, the player to the left of the first player goes second and soon. Said another way, the turns move clockwise when viewed from above.

In the arrangement shown, a player will roll both dice at the beginning of their turn. After rolling, the player will move the avatar the number of spaces appearing on the dice. The player can decide not to move so long as the player is on a property space. The player must move if the player rolls doubles, or the player must make an offer, or purchase the property space the player is currently occupying.

Rolling Doubles: Said another way, in the gameplay arrangement shown, as one example, the player rolling doubles must move, make an offer, or purchase the property space the player is occupying. Doubles allow a player to make a second consecutive turn, but not a third.

In the arrangement shown, as one example, players will land on one of the various types of spaces described herein. Players will continue to make decisions and move around the board. Players will execute various strategies and actions to acquire property at the correct time and grow a portfolio which helps the player achieve the goals required to win the game.

Turn Sequence: Further described herein.

Moving: Further described herein.

Property Spaces: Further described herein.

Value and Interest Spaces: Further described herein.

Peace and Crisis Spaces: Further described herein.

Income and Tax Space: Further described herein.

Offers: Further described herein.

Mortgages: Further described herein.

Buy Property (from Bank): Further described herein.

Buy Property (from Bank on Flip Street): Further described herein.

Buy Property (from Player): Further described herein.

Buy Card: Further described herein.

Sell Property (to Bank): Further described herein.

Sell Property (to Player): Further described herein.

Sell Card: Further described herein.

Trade Card: Further described herein.

Utilizing Peace Cards: Further described herein.

Utilizing Crises Cards: Further described herein.

Refinance: Further described herein.

Collect Rent: Further described herein.

Collect HOA Dues: Further described herein.

Pay Crises Card: Further described herein.

Pay Tax: Further described herein.

Pay Mortgage: Further described herein.

Winning: Further described herein.

Additional Gameplay: Further described herein.

HOA Cards: Further described herein.

Deed Cards: Further described herein.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A method of teaching real estate investment, comprising:
providing a system for electronic game play including at least one user; wherein the user includes an avatar in an electronic environment; wherein the user communicates with the electronic gameplay environment through communication devices having a display and graphical user interface;
generating an input into the system by the at least one user which generates an output corresponding to the input; wherein the system includes a memory and processor for storing information related to the processing, the input and the output;
registering and creating an avatar for at least one user on the graphical user interface;
generating gameplay information from a gameplay processor;
displaying a game board on the display of a user interface showing spaces, a plurality of dice, movement, and information related to purchasing, owning, selling, financing, mortgaging property, paying taxes;
including and utilizing virtual money in game play information;
making purchases using payment information associated with items requiring purchasing during gameplay;
providing information related to decisions made in game play including displaying information defining mortgages, taxes, and financial information; wherein the at least one user is educated about real world aspects incorporated into game play related to mortgages, buying, selling, taxes.

2. The method of claim 1, further comprising:
displaying on the game board a plurality of sections, each including a plurality of different property types; each of the plurality of property types having an associated set of property conditions; wherein each of the plurality of different property types occupies one space of many spaces creating a sequential board game.

3. The method of claim 1, further comprising:
moving an avatar to different spaces of the game board by rolling the plurality of dice which generate a random sum of movement spaces.

4. The method of claim 1, further comprising:
displaying on the game board a plurality of sections, each including a plurality of different property types; each of the plurality of property types having an associated set of property conditions; wherein each of the plurality of different property types occupies one space of many spaces creating a sequential board game;
generating a random game board arrangement including property spaces, value spaces, interest spaces, crisis spaces, income spaces, tax spaces.

5. The method of claim 1, further comprising:
displaying a real estate agent avatar which cooperates with a user; wherein the real estate agent avatar provides information to the user related to learning information and property information.

6. The method of claim 1, further comprising:
providing an application programming interface; wherein the application programming interface causes the electronic gameplay to display on a smart device.

7. The method of claim 1, further comprising:
providing a virtual ledger which tracks and displays game play activity and events in the gameplay; wherein the virtual ledger displays game play activity and events in chronological order.

8. A method of teaching real estate investment, through gameplay, comprising:
providing market conditions in which market conditions include market trends, interest rates, income, offers, mortgages banking information, financing information, refinance rates, costs associated with mortgages and closing, taxes, property insurance, and escrow.

9. The method of claim 1, further comprising:
providing a computing system with a communication system for enabling game play with a plurality of remote users at various locations such that a plurality of users can engage gameplay on the same virtual game board simultaneously;
providing a chat box such that users can send messages to one another through a remote computing system.

10. A method of teaching real-life financial values, comprising:
providing a system for electronic game play including at least one user; wherein the user includes an avatar in an electronic environment; wherein the user communicates with the electronic gameplay environment through communication devices having a display and graphical user interface;
generating an input into the system by the at least one user which generates an output corresponding to the input; wherein the system includes a memory and processor for storing information related to the processing, the input and the output;
registering and creating an avatar for at least one user on the graphical user interface;
generating gameplay information from a gameplay processor;
displaying a game board on the display of a user interface showing spaces;
including and utilizing a balance sheet associated with assets and liabilities of an avatar associated with a user;
making purchases using payment information associated with items requiring purchasing during gameplay;
providing information related to decisions made in game play including displaying information defining mortgages, taxes, and financial information; wherein the at least one user is educated about real world aspects incorporated into game play related to mortgages, buying, selling, taxes.

11. The method of claim 10, further comprising:
displaying on the game board a plurality of sections, each including a plurality of different property types; each of the plurality of property types having an associated set of property conditions; wherein each of the plurality of different property types occupies one space of many spaces creating a sequential board game.

12. The method of claim 10, further comprising:
moving an avatar to different spaces of the game board by rolling the plurality of dice which generate a random sum of movement spaces.

13. The method of claim 10, further comprising:
displaying on the game board a plurality of sections, each including a plurality of different property types; each of the plurality of property types having an associated set of property conditions; wherein each of the plurality of different property types occupies one space of many spaces creating a sequential board game;
generating a random game board arrangement including property spaces, value spaces, interest spaces, crisis spaces, income spaces, tax spaces.

14. The method of claim 10, further comprising:
displaying a real estate agent avatar which cooperates with a user; wherein the real estate agent avatar provides information to the user related to learning information and property information.

15. The method of claim 10, further comprising:
providing an application programming interface; wherein the application programming interface causes the electronic gameplay to display on a smart device.

16. The method of claim 10, further comprising:
providing a virtual ledger which tracks and displays game play activity and events in the gameplay; wherein the virtual ledger displays game play activity and events in chronological order.

17. The method of claim 10, further comprising:
providing market conditions in which market conditions include market trends, interest rates, income, offers, mortgages banking information, financing information, refinance rates, costs associated with mortgages and closing, taxes, property insurance, and escrow.

18. The method of claim 10, further comprising:
providing a computing system with a communication system for enabling game play with a plurality of remote users at various locations such that a plurality of users can engage gameplay on the same virtual game board simultaneously;
providing a chat box such that users can send messages to one another through a remote computing system.

19. An interactive application board game system for electronic gameplay, comprising:
one or more remote servers supporting an electronic environment and graphical user interface;
a plurality of remote users;
a plurality of electronic communication devices;
a first display of an electronic device having input capability and the capability to generate an output corresponding to the input;
the plurality of electronic devices having a memory for storage of information and processors for processing information;
the first display providing a game board with game board information;
the board game information including a plurality of property spaces, a plurality of value spaces, a plurality of peace spaces, a plurality of crisis spaces, a plurality of income spaces, and a plurality of tax spaces;
the game board including a plurality of dice;
wherein the plurality of remote users take turns rolling the plurality of dice, the plurality of dice indicating a movement across a plurality of spaces of the game board;
wherein each of the plurality of users having an avatar associated with an account and a portfolio;
wherein landing on the plurality of spaces have implications for each of the plurality of remote users avatars;
wherein the plurality of spaces and gameplay are designed to teach the plurality of remote users about finance, including market conditions, income, mortgages, banking, property, refinancing, rent, and taxes.

20. The system of claim 19, further comprising:
a home owning feature in which a user purchases and manages home ownership;
a homeowners association and an associated cost and associated homeowners association rules and regulations;
a turn sequence;
wherein a plurality of users take turns in game play by the associated turn sequence;
a virtual bank;
a flipping feature;
wherein repairs and improvements can be made to property;
a maintenance feature;
wherein maintenance can be made to property;
a collect rent feature;
a pay crisis feature.
